(19) United States
(12) Patent Application Publication
(10) Pub. No.: US 2013/0171675 A1
(43) Pub. Date: Jul. 4, 2013

(54) MEASURING DEVICE AND MEASURING METHOD

(71) Applicants: Akira Tsukamoto, Otsu-shi (JP); Jun Okamoto, Otsu-shi (JP)

(72) Inventors: Akira Tsukamoto, Otsu-shi (JP); Jun Okamoto, Otsu-shi (JP)

(73) Assignee: TOYOBO CO., LTD., Osaka-shi, Osaka (JP)

(21) Appl. No.: 13/824,107

(22) PCT Filed: Sep. 26, 2011
(86) PCT No.: PCT/JP2011/071826

§ 371 Date: Mar. 15, 2013

(30) Foreign Application Priority Data
Sep. 27, 2010 (JP) 2010-215914

(51) Int. Cl. G01N 21/78

(52) U.S. Cl. CPC G01N 21/78
USPC 435/14; 435/288.7

(57) ABSTRACT

The device enables measurement of both of blood glucose level and hemoglobin A1c level, being small-sized and thus portable, allowing the measurement of a small amount of a specimen and, being usable in POC. The device comprises: a test-piece-mounting section (1) for detachably mounting test pieces (200) on which the blood specimen is to be spotted; a light-emitting section (2) for emitting light for irradiating the test pieces; a light-receiving section (3) for receiving reflected lights from the test pieces; and an operating section (4) for calculating the blood glucose level and hemoglobin A1c level of the blood specimen on the basis of photometric values obtained from the light-receiving section. For measuring the blood glucose level of the blood specimen, test piece (A) carries a composition reacting with glucose and showing color change. Test piece (B) carries a composition reacting with glycated hemoglobin and showing color change.

### TECHNICAL FIELD

The present invention relates to a measuring device that can measure both a blood glucose level and a hemoglobin A1c level and a measuring method using the measuring device. More specifically, a measuring device according to the present invention is a small, simple measuring device usable at a so-called point of care (POC).

### BACKGROUND ART

In recent years, point-of-care (POC) tests have been attracting attention. POC tests are tests performed near patients or tests performed by patients themselves and include, for example, self-check tests performed by patients in their homes, tests performed at bedsides in hospitals, and tests performed in places other than central laboratories. Since doctors and patients can check the test results immediately, POC tests allow actions to be quickly taken and are expected to greatly contribute to improvement of the quality of treatment. Measuring devices used in POC tests (POC devices) are required to be small enough to be portable and perform tests with a small amount of specimen (for example, blood).

Devices for self-monitoring of blood glucose (SMBG) are an example of POC devices that are in widespread use. It is important to check the blood glucose level daily for diagnosis, prevention, and treatment of diabetes, and patients are recommended to measure the blood glucose level themselves for self management of their conditions. For this purpose, POC devices that are simple and capable of quickly measuring the blood glucose level by using several microliters of blood (whole blood) are extremely useful. Conventionally, POC devices for measuring the blood glucose level have used a method (enzyme colorimetric method) in which glucose contained in blood is caused to react with an enzyme and develop color. The level of color development is detected in terms of absorbance and converted into an amount of glucose. In recent years, however, devices using an oxygen electrode method, for which the device structure is relatively simple, have become popular. In the oxygen electrode method, glucose contained in blood is caused to react with an enzyme and generate a current, and the value of the generated current is converted into an amount of glucose.

Hemoglobin A1c (glycated hemoglobin), which is one of glycated proteins, is known as another index used for diagnosis, etc., of diabetes. Hemoglobin A1c is an index that reflects a one to two months history of the blood glucose level of a living body, and shows a long-term average of the blood glucose level. Therefore, for accurate diagnosis and treatment, the hemoglobin A1c level is preferably checked in addition to the blood glucose level, which varies by large amounts in the short term. However, known methods for measuring the hemoglobin A1c level are difficult to apply to the above-described POC devices, and measurement of the hemoglobin A1c level has been performed only in central laboratories of hospitals and inspection institutes.

More specifically, in an example of a known method for measuring the hemoglobin A1c level, the hemoglobin A1c level is measured in terms of a glycation rate or an amount of glycation by, for example, a high performance liquid chromatography (HPLC) method or an immunization method. However, in the HPLC method, a large specialized machine is required to only measure a hemoglobin A1c level. In the immunization method, the measurement accuracy decreases unless, for example, contamination of a measurement cell is sufficiently controlled. Owing to these circumstances, measurement of the hemoglobin A1c level by these methods has been performed only in hospitals and inspection institutes.

As another example of a method for measuring the hemoglobin A1c level, PTL 1 discloses a method using a redox reaction caused by an enzyme. In this method for measuring the hemoglobin A1c level using a redox reaction caused by an enzyme, first, a sample containing hemoglobin A1c is treated with fructosyl-amino acid oxidase (FAOD) so that the FAOD acts on a glycated portion of the hemoglobin A1c. Accordingly, hydrogen peroxide, the amount of which corresponds to an amount of hemoglobin A1c, is generated. Then, peroxidase (POD) and a reducing agent are added so that a redox reaction occurs between the hydrogen peroxide and the reducing agent with the POD serving as a catalyst. The amount of generated hydrogen peroxide can be measured by using a reducing agent that develops color when oxidized and detecting the level of color development of the obtained reaction liquid in terms of absorbance. As a result, the amount of hemoglobin A1c can be measured.

However, the method described in PTL 1 is a so-called wet measuring method in which the absorbance of the reaction liquid obtained by the redox reaction is measured. Therefore, it is necessary to prepare the reaction liquid, and complex management and maintenance are required. For this reason, it is difficult to apply this method to the above-described POC tests, in particular, to self-check tests performed by patients. PTL 2 proposes a method for measuring the hemoglobin A1c level by using a glycated hemoglobin measurement cassette to minimize the operational burden on the operator and reduce the measurement time. However, this method is also a wet measuring method, and is difficult to apply to the above-described POC tests, in particular, to self-check tests performed by patients.

A hemoglobin A1c level measuring method applicable to POC tests is proposed in PTL 3. This method is a combination of the immunization method and a colorimetric method in which the level of color development is detected in terms of absorbance. However, since this method is based on the immunization method, it is necessary to prepare a diluent obtained by hemolyzing a blood specimen (whole blood) in advance. Therefore, the measurement according to this method is more complex compared to the measurement using the devices for self-monitoring of blood glucose (SMBG), with which the measurement can be performed by simply using whole blood.

In recent years, greater importance has been placed on the hemoglobin A1c level in diagnosis, prevention, and treatment of diabetes. For example, in the United States, where diagnosis of diabetes has conventionally been performed on the basis of a fasting blood sugar or the result of a glucose tolerance test, the American Diabetes Association (ADA) announced that the hemoglobin A1c level may be used as a new diagnostic criterion in June, 2009. In Japan, it has been recommended since Jul. 1, 2010 that hemoglobin A1c be included in essential test items for diagnosis of diabetes in addition to conventional test items such as the blood glucose level. Accordingly, it is preferable that not only the blood glucose level but also the hemoglobin A1c level be able to be measured by patients themselves for self management of their conditions or be able to be measured more easily and quickly at medical sites.

The above-described blood glucose level and hemoglobin A1c level are both used in diagnosis of diabetes. In particular, the blood glucose level and the hemoglobin A1c level are both included in the essential test items for diagnosis of diabetes in Japan. Therefore, for convenience, for example, these measurement items are preferably measurable with a single device.

A glycosylated hemoglobin/glucose analyzer “ADAMS (registered trade mark) Hybrid AH-8280” is commercially available from Arkray, Inc. as a device capable of measuring the blood glucose level and the hemoglobin A1c level at the same time. This device, however, measures the blood glucose level by a glucose oxidase electrode method and the hemoglobin A1c level by the HPLC method, and two different measurement principles are used. Therefore, the device has a complex inner structure and a large size, and cannot be used at a POC, even though the device has an advantage in that the installation space therefor is smaller than that in the conventional case where the blood glucose level and the hemoglobin A1c level are measured with different devices. In addition, “Banalyst (registered trade mark) Ace”, which has been developed by Rohm Co., Ltd., Sanwa Kagaku Kenkyusho Co., Ltd., and Ushio, Inc., is also commercially available as a device capable of measuring the blood glucose level and the hemoglobin A1c level at the same time. This device, however, measures the blood glucose level by an enzyme method and the hemoglobin A1c level by the immunization method, such as a latex agglutination method, and so also in this device, two different measurement principles are used. Therefore, the device has a complex structure, and is difficult to apply to POC tests, in particular, to self-check tests performed by patients.

PTL 4 proposes self-testing blood sugar testing means for simultaneously measuring a current blood glucose level and a blood sugar marker that reflects the blood glucose level in the past. However, no actual device that can measure the blood glucose level and the hemoglobin A1c level is disclosed. In recent years, devices for self-monitoring of blood glucose (SMBG) capable of measuring not only the blood glucose level but also other test items have been developed and become commercially available. For example, “Benecheck (registered trade mark) PLUS” manufactured by General Life Biotechnology Co., Ltd. in Taiwan can measure not only the blood glucose level but also a cholesterol level and an uric acid level by the oxygen electrode method. However, this device also cannot measure the hemoglobin A1c level together with the blood glucose level.

### CITATION LIST

### Patent Literature

PTL 1: International Publication No. 2003/064683
PTL 2: Japanese Unexamined Patent Application Publication No. 2009-92643
PTL 3: U.S. Unexamined Patent Application Publication No. 2005/0158866
PTL 4: Japanese Unexamined Patent Application Publication No. 2001-264336

### SUMMARY OF INVENTION

### Technical Problem

The present invention has been made in light of the above-described circumstances, and an object of the present invention is to provide a measuring device that can measure both a blood glucose level and a hemoglobin A1c level, that is small enough to be portable, that can perform a measurement with a small amount of specimen, and that is usable at a POC, and a measuring method using the measuring device.

### Solution to Problem

A measuring device according to the present invention, which achieves the above-described object, is a device for measuring a blood glucose level and a hemoglobin A1c level of a blood specimen and includes a light-emitting section that emits illuminating light toward the blood specimen; a light-receiving section that receives reflected light from the blood specimen; and an operating section that calculates each of the blood glucose level and the hemoglobin A1c level of the blood specimen on the basis of a photometric value obtained from the light-receiving section. The light-emitting section is capable of emitting two or more types of light having different wavelengths. The light-emitting section is preferably capable of emitting three types of light having different wavelengths. In this case, one of the three types of light having different wavelengths is light having a specific wavelength that is absorbed by a portion whose color has changed in response to glucose contained in the blood specimen and the remaining two of the three types of light having different wavelengths are two types of light having different specific wavelengths that are absorbed by respective portions whose colors have changed in response to hemoglobin and glycated hemoglobin contained in the blood specimen. The measuring device preferably further includes a test-piece-mounting section that detachably mounts a test piece to which the blood specimen is applied.

Another measuring device according to the present invention is a device for measuring a blood glucose level and a hemoglobin A1c level of a blood specimen and includes a test-piece-mounting section that detachably mounts a test piece to which the blood specimen is applied; a light-emitting section that emits illuminating light toward the test piece; a light-receiving section that receives reflected light from the test piece; and an operating section that calculates each of the blood glucose level and the hemoglobin A1c level of the blood specimen on the basis of a photometric value obtained from the light-receiving section. A test piece (A) that carries a composition (a) that reacts with glucose and changes color is mounted as the test piece to measure the blood glucose level of the blood specimen, and a test piece (B) that carries a composition (b) that reacts with glycated hemoglobin and changes color is mounted as the test piece to measure the hemoglobin A1c level of the blood specimen. In this measuring device, similar to the above-described measuring device, the light-emitting section is preferably capable of emitting three types of light having different wavelengths.

In the above-described measuring device according to the present invention, the blood glucose level and the hemoglobin A1c level are both measured by a method based on the same measurement principle in which the test piece is caused to change color in response to a reaction, and the level of the color change is detected by using reflection of light. Therefore, the size of the device can be reduced. Since the test piece carries a composition that reacts with glucose or glycated hemoglobin contained in the blood specimen, the above-described reaction for causing the test piece to change color can be caused by applying a few drops (about several microliters) of blood specimen (whole blood) directly to the test piece without diluting the blood specimen. The above-described measuring device according to the present invention can be used as a POC device. The blood glucose level can be measured when the test piece (A) is mounted as the test piece and the hemoglobin A1c level can be measured when the test piece (B) is mounted as the test piece.

The test pieces (A) and (B) according to the present invention are not necessarily formed separately, and may be formed as a single test piece. For example, the test piece to which the blood specimen is applied may include both a region in which the composition (a) is carried (which corresponds to the test piece (A)) and a region in which the composition (b) is carried (which corresponds to the test piece (B)).

The measuring device according to the present invention measures both the blood glucose level and the hemoglobin A1c level on the basis of a measurement principle in which a color change is caused and the level of the color change is detected in terms of the level of reflection of light. For this purpose, it is important that the light-emitting section be capable of emitting two types of light having different wavelengths. In other words, to measure the blood glucose level and the hemoglobin A1c level with a single device on the basis of the above-described measurement principle, at least two types of light having different wavelengths are required, the wavelengths including a wavelength for detecting a color change caused by glucose to measure the blood glucose level and a wavelength for detecting a color change caused by glycated hemoglobin to measure the hemoglobin A1c level.

In a measuring device according to a preferred embodiment of the present invention, the hemoglobin A1c level is measured by detecting a color change caused by hemoglobin and a color change caused by glycated hemoglobin and calculating the hemoglobin A1c level on the basis of the detection results. In this case, the color change caused by hemoglobin and the color change caused by glycated hemoglobin are preferably detected by using reflection of light having different wavelengths, and the two different wavelengths (the wavelength for detecting the color change caused by hemoglobin and the wavelength for detecting the color change caused by glycated hemoglobin) preferably differ from the wavelength for detecting the color change caused by glucose. When the light-emitting section is capable of emitting three types of light having different wavelengths, the color change caused by hemoglobin, the color change caused by glycated hemoglobin, and the color change caused by glucose can be detected by using reflection of light having different wavelengths. In the case where two of the color change caused by hemoglobin, the color change caused by glycated hemoglobin, and the color change caused by glucose can be detected with the same wavelength, the light-emitting section may be capable of emitting two types of light having different wavelengths.

The above-described light-emitting section capable of emitting two or more types of light having different wavelengths may include two or more light-emitting elements, each of which is capable of emitting light having a single wavelength. The light-emitting section preferably includes at least one light-emitting element capable of emitting two or more types of light having different wavelengths (multiple-wavelength light-emitting element). In this case, the number of light-emitting elements included in the device can be reduced, and the size of the device can be reduced accordingly.

Most preferably, the light-emitting section includes a light-emitting element capable of emitting three types of light having different wavelengths. In this case, the color change caused by glucose, the color change caused by glycated hemoglobin, and the color change caused by hemoglobin can be detected with light having different wavelengths by using a single light-emitting element.

It is also preferable that the light-emitting section capable of emitting two or more or three types of light having different wavelengths include three light-emitting elements (each of which may either be, for example, a light-emitting element capable of emitting light having a single wavelength or a multiple-wavelength light-emitting element), one of which emits light toward one side of the test piece and the remaining two of which emit light toward the other side of the test piece. More specifically, for example, two light-emitting elements may be arranged one on each side (each of front and back sides) of the test piece so that one of the light-emitting elements emits light toward the front surface of the test piece and the other light-emitting element emits light toward the back surface of the test piece. In this case, two types of light having different wavelengths can be simultaneously emitted toward the test piece, so that the measurement speed can be increased.

The light-emitting section preferably includes at least one light-emitting element having a peak wavelength of 600 nm or more and a luminous intensity of 1000 mcd or more, more preferably 2000 mcd or more, and still more preferably 3000 mcd or more. In this case, the light at the high wavelength side can be reliably received (detected) and the measurement accuracy can be increased.

In the measuring device according to the present invention, preferably, two of the test-piece-mounting sections are provided, the test piece (A) being mounted by one of the two test-piece-mounting sections and the test piece (B) being mounted by the other of the two test-piece-mounting sections, and the test pieces (A) and (b) have different shapes or sizes. In other words, when a test-piece-mounting section for measuring the blood glucose level and a test-piece-mounting section for measuring the hemoglobin A1c level are provided, the test pieces to be mounted by the respective test-piece-mounting sections preferably have different shapes or sizes. In this case, insertion of the wrong one of the test pieces (A) and (B) can be prevented.

In the measuring device according to the present invention, preferably, the test-piece-mounting section has a test-piece-receiving hole, and the test-piece-receiving hole has an edge portion that guides the test piece (A) and an edge portion that guides the test piece (B), which has a shape different from a shape of the test piece (A). In this case, the size of the device can be reduced since only one test-piece-mounting section is provided, and insertion of the wrong one of the test pieces (A) and (B) can be prevented.

A measuring method of the present invention, which achieves the above-described object, includes measuring both a blood glucose level and a hemoglobin A1c level of a blood specimen by using a measuring device including a light-emitting section capable of emitting two or more types (in particular, three types) of light having different wavelengths. Another measuring method according to the present invention uses a measuring device including a test-piece-mounting section that detachably mounts a test piece to which a blood specimen is applied, a light-emitting section that emits illuminating light toward the test piece, a light-receiving section that receives reflected light from the test piece, and an operating section that each of a blood glucose level and a hemoglobin A1c level of the blood specimen on the basis of a photometric value obtained from the light-receiving section. A test piece (A) that carries a composition (a) that reacts with glucose and changes color is used as the test piece when the blood glucose level of the blood specimen is to be measured, and a test piece (B) that carries a composition (b) that reacts with glycated hemoglobin and changes color is used as the test piece when the hemoglobin A1c level of the blood specimen is to be measured. The measuring method includes applying the blood specimen to the test piece, emitting the illuminating light toward the test piece with the light-emitting section, receiving the reflected light from the test piece with the light-receiving section, and calculating the blood glucose level or the hemoglobin A1c level with the operating section on the basis of the obtained photometric value. With the measuring method according to the present invention, the blood glucose level and the hemoglobin A1c level can both be appropriately measured by two simple processes of applying the blood specimen to the test piece and mounting the test piece.

In the measuring method according to the present invention, in the case where the measuring device includes one of the test-piece-mounting section, preferably, the test piece (A) is mounted by the one test-piece-mounting section when the blood glucose level of the blood specimen is to be measured and the test piece (B) is mounted by the one test-piece-mounting section when the hemoglobin A1c level of the blood specimen is to be measured. When only one test-piece-mounting section is provided and the test piece corresponding to the measurement item (the blood glucose level or the hemoglobin A1c level) is mounted by the test-piece-mounting section as appropriate, the size of the device can be reduced.

According to the present invention, preferably, the composition (a) carried by the test piece (A) contains glucose oxidase, peroxidase, and a redox color reagent, and the composition (b) carried by the test piece (B) contains protease, fructosyl-amino acid oxidase, peroxidase, and a redox color reagent. In this case, the color of the test piece can be reliably and efficiently changed by glucose and glycated hemoglobin contained in the blood specimen.

### Advantageous Effects of Invention

According to the present invention, the blood glucose level and the hemoglobin A1c level can both be measured with a single device that can be used at a POC. More specifically, the present invention has an advantage that patients can measure the hemoglobin A1c level together with the blood glucose level simply by using a few drops of blood as the specimen, and POC tests for diabetes can be easily performed not only at hospitals but also at homes.

In particular, since the measuring device according to the present invention measures both the blood glucose level and the hemoglobin A1c level on the basis of the same measurement principle, simplification and size reduction of the device can be easily achieved. The measuring method according to the present invention is a so-called dry measuring method in which the blood specimen is applied to the test piece and subjected to the measurement. Therefore, it is not necessary to perform dilution, centrifugal separation, equipment cleaning, etc., which are essential in wet measuring methods, such as the conventional methods for measuring the hemoglobin A1c level based on the immunization method or the enzyme colorimetric method. Since the measuring method according to the present invention is a dry measuring method, the measurement can be performed by using a small amount of specimen, and the test piece to which the blood specimen is applied can be easily handled. In addition, the test piece is disposable, and can be easily disposed of after use. This is also advantageous from the viewpoint of hygiene and infection prevention.

### BRIEF DESCRIPTION OF DRAWINGS

FIG. 1 is a perspective view of a measuring device according to an embodiment of the present invention and test pieces to be mounted into the measuring device.

FIG. 2 is a schematic sectional view of the measuring device illustrated in FIG. 1 taken along line x-x when a test piece (A) is mounted in the measuring device.

FIG. 3 is a schematic sectional view of the measuring device illustrated in FIG. 1 taken along line y-y when a test piece (B) is mounted in the measuring device.

FIG. 4 is a schematic diagram illustrating a measuring device according to another embodiment of the present invention, and, similar to FIG. 3, is a schematic sectional view of the measuring device illustrated in FIG. 1 taken along line y-y when a test piece (B) is mounted into the measuring device.

FIG. 5 is a schematic sectional view of a light-emitting section and a light-receiving section of a measuring device according to another embodiment of the present invention.

FIG. 6 is a schematic sectional view of a light-emitting section and a light-receiving section of a measuring device according to another embodiment of the present invention.

FIG. 7 is a perspective view of a blood collection needle that can be used to collect a blood specimen to be subjected to a measurement according to an embodiment of the present invention.

FIG. 8 is a perspective view of a measuring device and a test piece to be mounted into the measuring device according to another embodiment of the present invention.

FIG. 9 shows perspective views of a measuring device and test pieces to be mounted into the measuring device according to another embodiment of the present invention.

FIG. 10 shows perspective views of test-piece-receiving holes formed in test-piece-mounting sections of measuring devices according to other embodiments of the present invention.

FIG. 11 is a perspective view of a measuring device and test pieces to be mounted onto the measuring device according to another embodiment of the present invention.

FIG. 12 is a perspective view of a measuring device and a test piece to be mounted onto the measuring device according to another embodiment of the present invention.

FIG. 13 is a schematic sectional view of a light-emitting section and a light-receiving section of a measuring device according to another embodiment of the present invention.

### DESCRIPTION OF EMBODIMENTS

(Measuring Device)

A measuring device according to the present invention measures a blood glucose level and a hemoglobin A1c level of a blood specimen by using a predetermined test piece or test pieces. Hereinafter, the measuring device according to the present invention will be described with reference to the drawings.

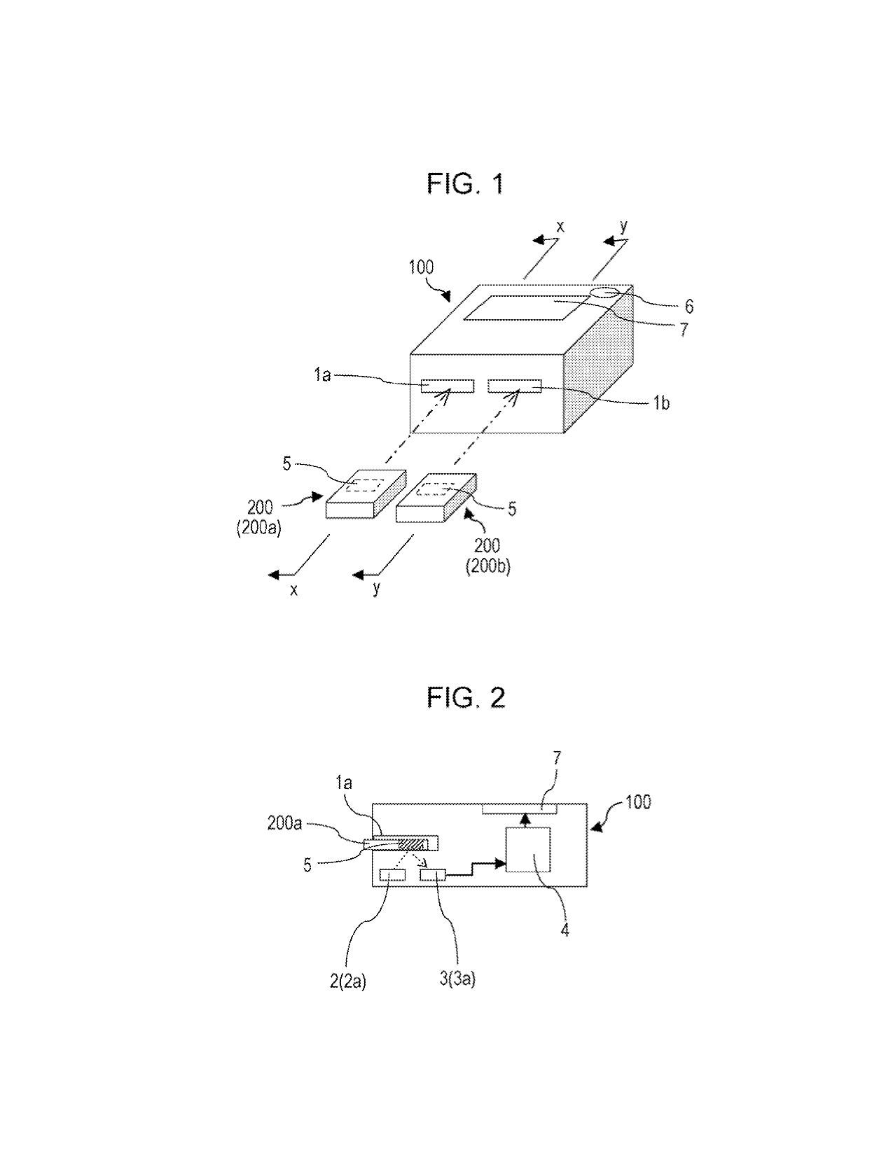

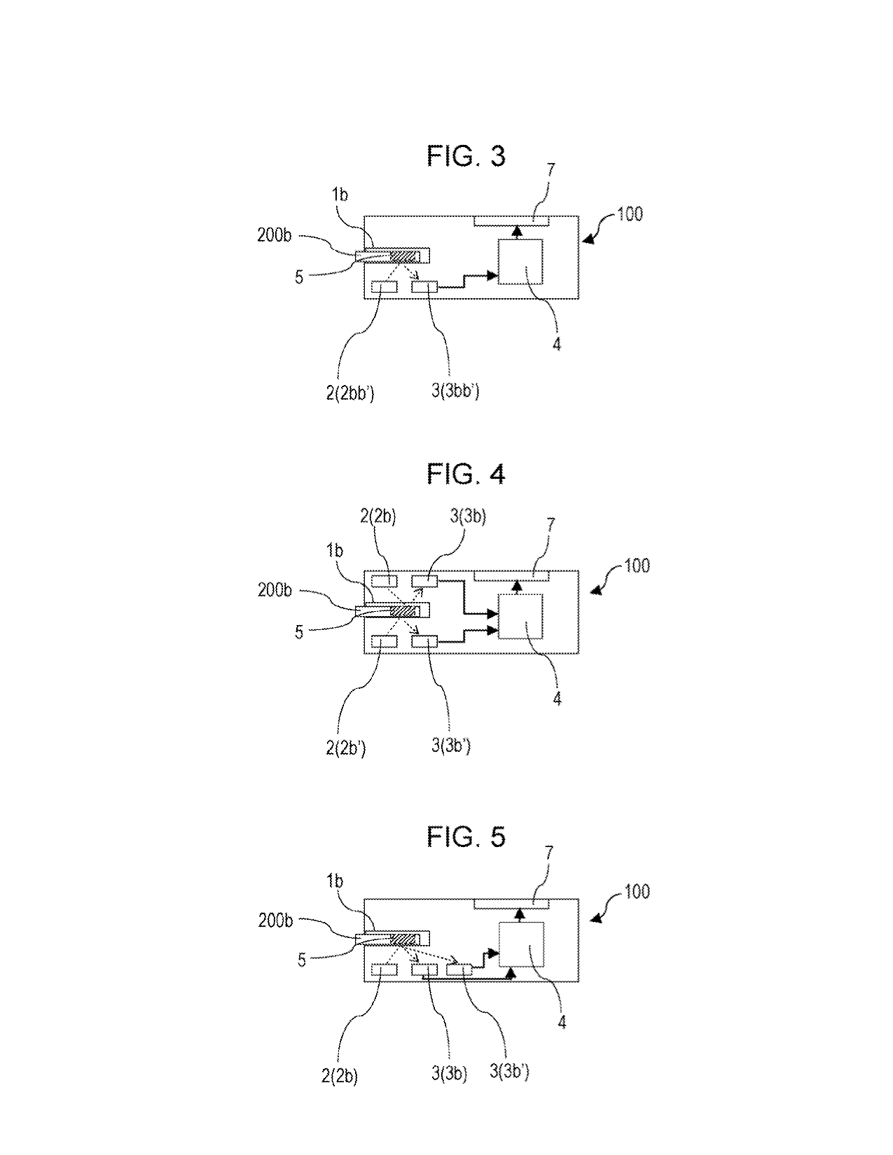

FIG. 1 is a perspective view of a measuring device 100, which is a measuring device according to an embodiment of the present invention, and test pieces 200 to be mounted into the measuring device 100. FIG. 2 is a schematic sectional view of the measuring device 100 illustrated in FIG. 1 taken along line x-x when a test piece (A) (200a) for measuring a blood glucose level is mounted in the measuring device 100 as one of the test pieces 200. FIG. 3 is a schematic sectional view of the measuring device 100 illustrated in FIG. 1 taken along line y-y when a test piece (B) (200b) for measuring a hemoglobin A1c level is mounted in the measuring device 100 as another one of the test pieces 200.

Referring to FIGS. 1 to 3, the measuring device 100 according to the present invention includes test-piece-mounting sections 1 into which the test pieces 200, to which the blood specimen is applied, are detachably mounted; a light-emitting section 2 that emits illuminating light toward the test pieces 200; a light-receiving section 3 that receives reflected light from the test pieces 200; and an operating section 4 that calculates a blood glucose level and a hemoglobin A1c level of the blood specimen on the basis of photometric values obtained from the light-receiving section 3.

Although the measuring device 100 illustrated in FIGS. 1 to 3 includes two test-piece-mounting sections 1, the number of test-piece-mounting sections 1 may instead be one, as illustrated in FIG. 8. When the test pieces 200 are mounted into the measuring device 100 illustrated in FIGS. 1 to 3 which includes the two test-piece-mounting sections 1, one test-piece-mounting section 1a receives the test piece (A) (200a) for measuring the blood glucose level, which will be described below, and the other test-piece-mounting section 1b receives the test piece (B) (200b) for measuring the hemoglobin A1c level, which will be described below. In the case where only one test-piece-mounting section 1 is provided, the test pieces 200 may be selectively mounted as appropriate so that the test-piece-mounting section 1 receives the test piece (A) when the blood glucose level is to be measured and receives the test piece (B) when the hemoglobin A1c level is to be measured. Although two test-piece-mounting sections 1 are preferably provided to increase the measurement speed, the number of test-piece-mounting sections 1 is preferably only one from the viewpoint of reducing the size of the device.

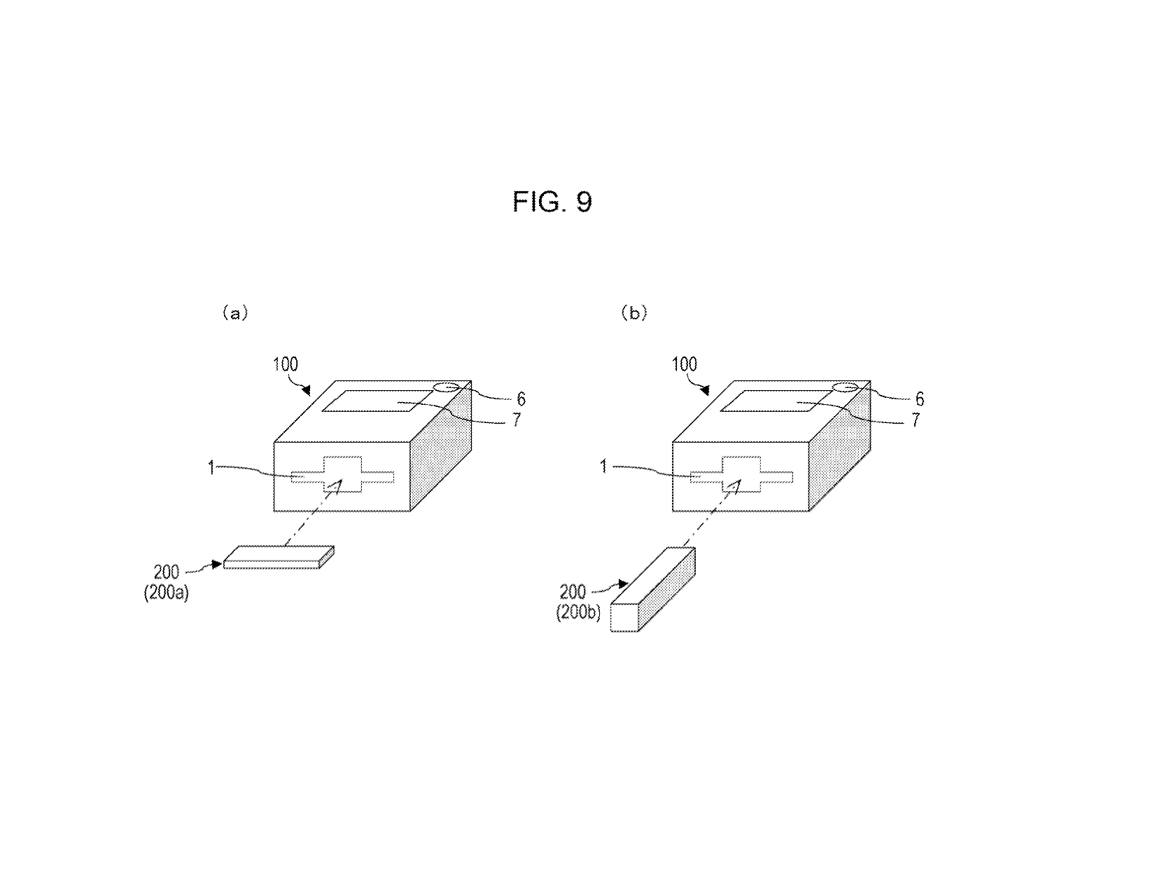

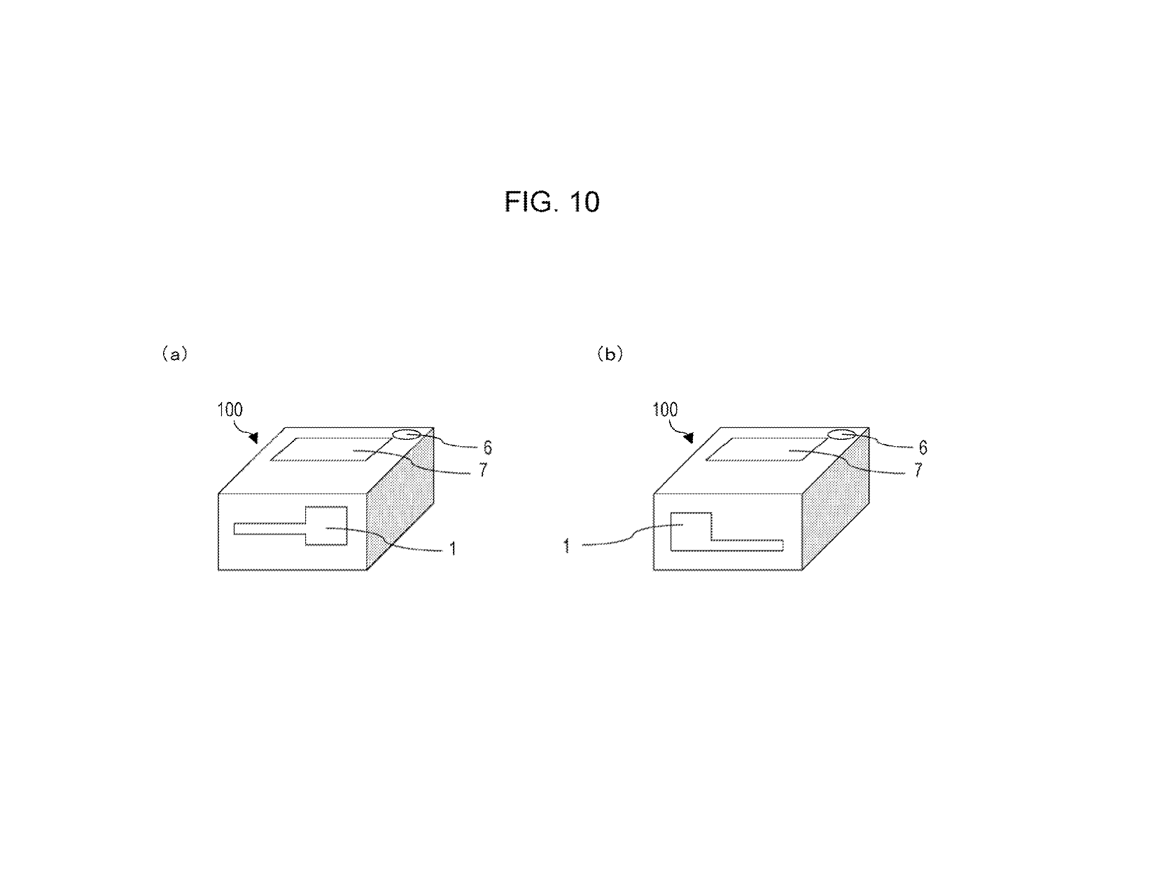

In the measuring device 100 illustrated in FIGS. 1 to 3 and in the configuration illustrated in FIG. 8, each test-piece-mounting section 1 has a rectangular test-piece-receiving hole. However, in the case where there is only one test-piece-receiving hole in the test-piece-mounting section 1, the test-piece-receiving hole is preferably shaped so as to have an edge portion that guides the test piece (A) for measuring the blood glucose level and an edge portion that guides the test piece (B) for measuring the hemoglobin A1c level. For example, the test-piece-receiving hole may be cross-shaped as illustrated in FIG. 9, T-shaped as illustrated in FIG. 10(a), or L-shaped as illustrated in FIG. 10(b). In the case where only one test-piece-mounting section 1 is provided to reduce the size of the device, if, for example, the test-piece-receiving hole has a simple rectangular shape as illustrated in FIG. 8, the test piece (A) and the test piece (B) are necessarily formed in the same shape. In such a case, there is a risk that a wrong test piece will be inserted, for example, the test piece (B) for measuring the hemoglobin A1c level will be inserted when the blood glucose level is to be measured. However, when the test-piece-receiving hole is shaped as illustrated in FIGS. 9 and 10, the test piece (A) and the test piece (B) may be formed in obviously different shapes. This contributes to preventing the insertion of the wrong test piece.

In the case where the test-piece-receiving hole in the test-piece-mounting section 1 is cross-shaped as illustrated in FIG. 9, a test piece 200a illustrated in FIG. 9(a), for example, which has a small dimension (thickness) in the vertical direction of the device is preferably selected as the test piece (A) for measuring the blood glucose level, and a test piece illustrated in FIG. 9(b), for example, which has a large dimension (thickness) in the vertical direction of the device is preferably selected as the test piece (B) for measuring the hemoglobin A1c level. The reason for this is as follows. That is, although the test piece (A) for measuring the blood glucose level and the test piece (B) for measuring the hemoglobin A1c level have a multilayer structure in which a plurality of layers are stacked, the test piece (A) for measuring the blood glucose level generally have a smaller number of layers and can be more easily reduced in thickness compared to the test piece (B) for measuring the hemoglobin A1c level.

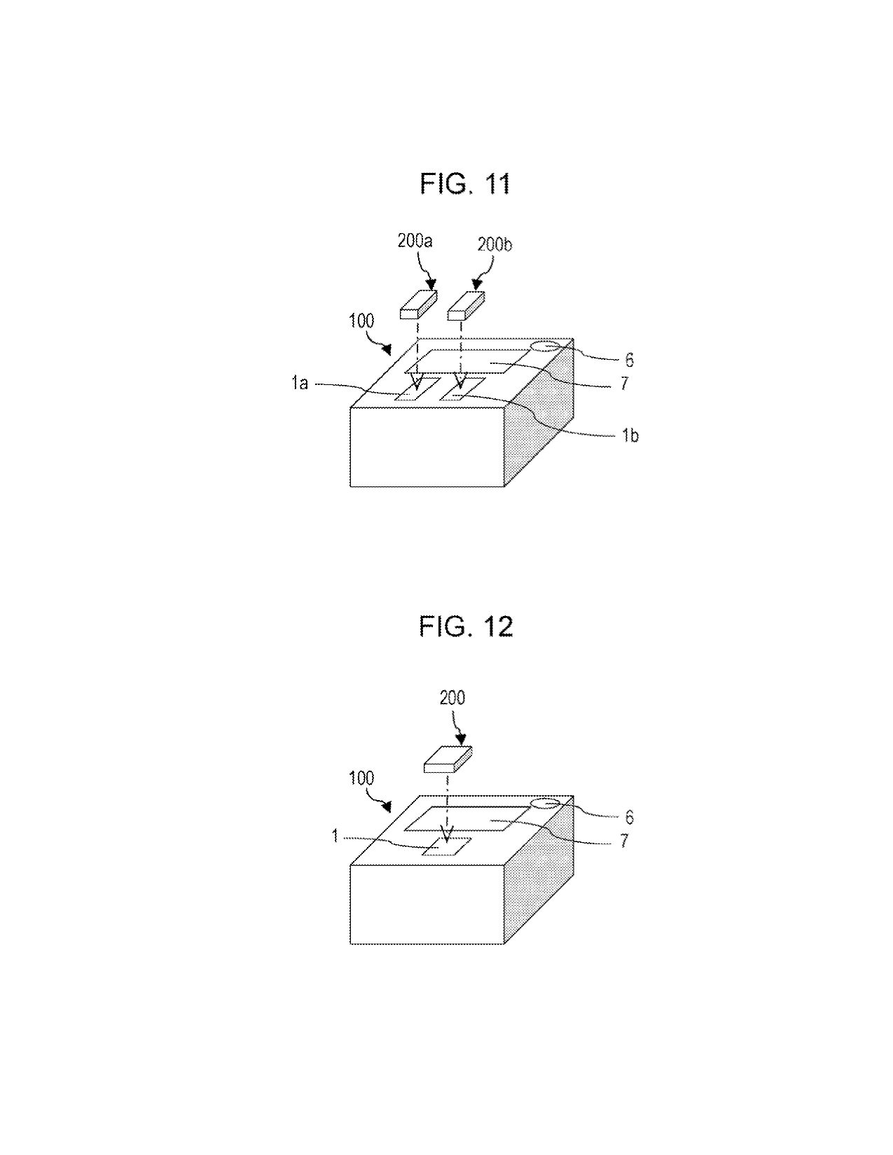

In the measuring device 100 illustrated in FIG. 1, the test-piece-mounting sections 1 (1a and 1b) are formed in a side surface of a main body of the device. However, locations of the test-piece-mounting sections 1 are not particularly limited. For example, as illustrated in FIGS. 11 and 12, the test-piece-mounting sections 1 may be formed in the top surface of the main body of the device, and the test pieces may be placed onto the test-piece-mounting sections 1 from above.

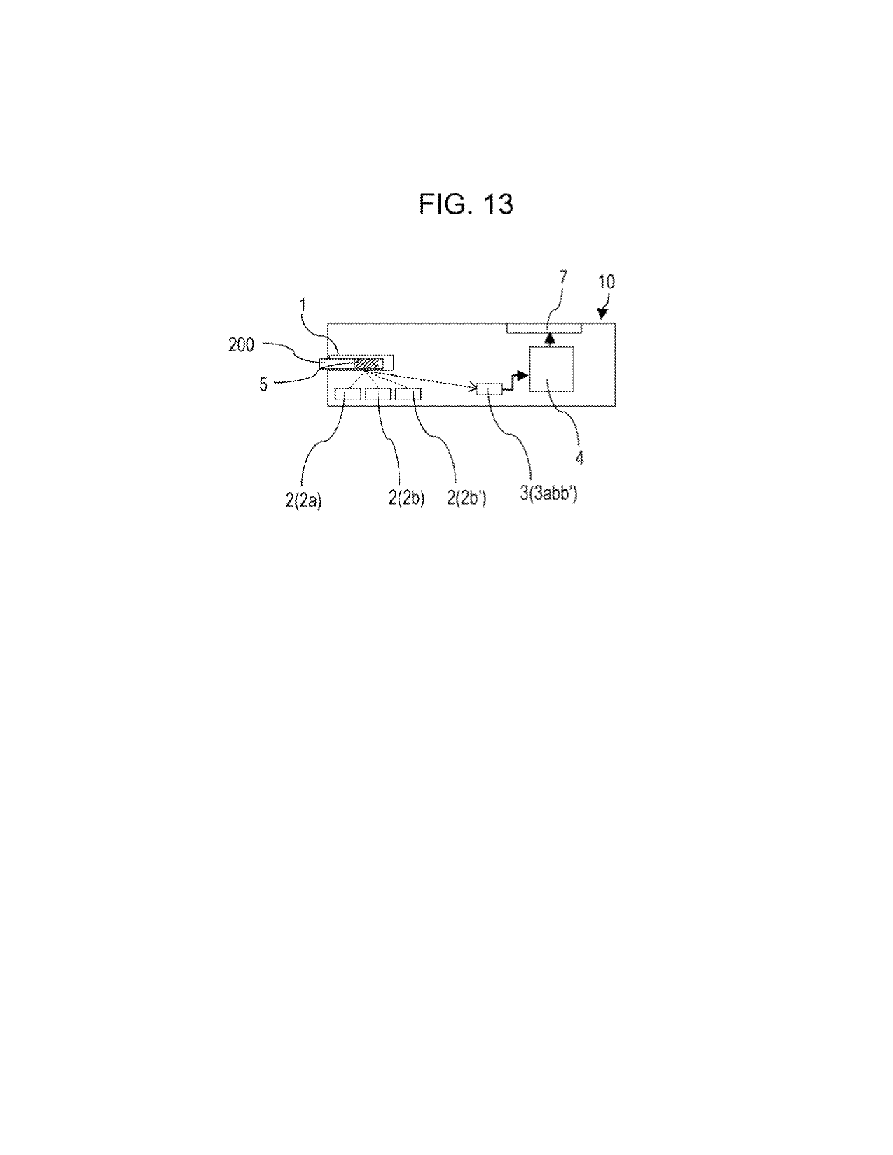

The light-emitting section 2 includes one, two, or more light-emitting elements, and is arranged so that illuminating light can be emitted toward the test pieces 200 mounted in the test-piece-mounting sections 1 (more specifically, toward blood-specimen-applying portions 5 of the test pieces 200 to which the blood specimen is applied) (in the drawings, the dotted lines show the trajectories of light). In the case where a plurality of light-emitting elements are provided, all of the light-emitting elements may be arranged on one side (front side or back side) of the test pieces 200. Alternatively, the light-emitting elements may be arranged on both sides (front side and back side) of the test pieces 200. All of the light-emitting elements are preferably arranged on one side of the test pieces 200, as illustrated in FIG. 13, from the viewpoint of reducing the thickness and size of the device. Preferably, the light-emitting elements are arranged on the back side of the test pieces 200.

Although the light-emitting section 2 may include any number of light-emitting elements as described above, the light-emitting section 2 is preferably capable of emitting three types of light having different wavelengths. Although the measurement principle of the device according to the present invention will be described in detail below, the device according to the present invention basically measures the hemoglobin A1c level by detecting a color change caused by hemoglobin and a color change caused by glycated hemoglobin and calculating the hemoglobin A1c level on the basis of the result of the detection. The color change caused by hemoglobin and the color change caused by glycated hemoglobin are preferably detected by using reflection of light having different wavelengths. For this purpose, the light-emitting section 2 is preferably capable of emitting two types of light having different wavelengths. In addition, a color change caused by glucose that is detected to measure the blood glucose level is preferably detected by using reflection of light having a wavelength different from those of the light used to detect the color changes caused by hemoglobin and glycated hemoglobin. Therefore, the light-emitting section 2 is preferably capable of emitting three types of light having different wavelengths.

In order for the light-emitting section 2 to be capable of emitting three types of light having different wavelengths as described above, the light-emitting section 2 preferably includes at least one light-emitting element capable of emitting two or more types of light having different wavelengths (multiple-wavelength light-emitting element). In the case where a multiple-wavelength light-emitting element is used as at least one of the light-emitting elements included in the light-emitting section 2 so that three types of light having different wavelengths can be emitted, the number of light-emitting elements included in the device can be reduced. As a result, the size of the device can be reduced.

The light-emitting section 2 that is capable of emitting three types of light having different wavelengths preferably includes at least two light-emitting elements (each of which may either be, for example, a light-emitting element capable of emitting light having a single wavelength or a multiple-wavelength light-emitting element). In such a case, the hemoglobin A1c level can be measured by simultaneously emitting two types of light having different wavelengths toward the test piece. As a result, the measurement speed can be increased.

In the measuring device 100 illustrated in FIGS. 1 to 3, the light-emitting section 2 includes a light-emitting element 2a illustrated in FIG. 2 and a light-emitting element 2bb′ illustrated in FIG. 3. The light-emitting element 2a emits illuminating light toward the blood-specimen-applying portion 5 of the test piece (A) (200a) for measuring the blood glucose level that is mounted in the test-piece-mounting section 1a. The light-emitting element 2bb′ emits illuminating light toward the blood-specimen-applying portion 5 of the test piece (B) (200b) for measuring the hemoglobin A1c level that is mounted in the test-piece-mounting section 1b. The light-emitting element 2bb′ is a multiple-wavelength light-emitting element, and emits light having a wavelength for detecting a color change caused by hemoglobin and light having a wavelength for detecting a color change caused by glycated hemoglobin. The light-emitting element 2a is not limited as long as the light-emitting element 2a can emit light having a wavelength for detecting a color change caused by glucose.

Instead of the light-emitting element 2bb′ illustrated in FIG. 3, the light-emitting section 2 may include two light-emitting elements 2b and 2b′ as illustrated in FIG. 4. In the configuration illustrated in FIG. 4, the two light-emitting elements 2b and 2b′ are arranged one on each side (each of front and back sides) of the test piece 200b. One light-emitting element 2b emits light toward the front surface of the test piece 200b, and the other light-emitting element 2b′ emits light toward the back surface of the test piece 200b. In the configuration illustrated in FIGS. 1, 2, and 4, two light-emitting elements 2a and 2b′ are arranged at one side of the device (back side of the test piece) and one light-emitting element 2b is arranged at the other side of the device (front side of the test piece) across the test piece. Since the light-emitting elements are arranged at one and the other sides of the device, the size of the device can be reduced.

Alternatively, as illustrated in FIG. 13, the light-emitting section 2 may include three light-emitting elements 2a, 2b, and 2b′ on one side of the test piece.

The light-emitting section 2 preferably includes one, two, or more light-emitting elements that emit light having peak wavelengths in the range of 450 nm to 780 nm, preferably in the ranges of 450 nm to 550 nm and 600 nm to 700 nm, and more preferably in the ranges of 450 nm to 500 nm and 630 nm to 700 nm. Accordingly, the test piece that has changed color can be irradiated with light having a wavelength suitable for detecting the color change. For example, light having a wavelength in the range of 450 nm to 550 nm, more preferably 450 to 500 nm, may be emitted to detect a color change caused by hemoglobin, and light having wavelengths in the range of 600 nm to 700 nm, more preferably 630 nm to 700 nm, may be emitted to detect a color change caused by glucose and a color change caused by glycated hemoglobin. Examples of the light-emitting elements include a blue light-emitting diode, a green light-emitting diode, and a red light-emitting diode.

The light-emitting section 2 preferably includes light-emitting elements having a luminous intensity of 1000 mcd or more, more preferably includes light-emitting elements having a luminous intensity of 2000 mcd or more, and still more preferably includes light-emitting elements having a luminous intensity of 3000 mcd or more. At least one of the light-emitting elements has a peak wavelength in the range of 600 nm or more and 700 nm or less and a luminous intensity of 1000 mcd or more, more preferably 2000 mcd or more, and still more preferably 3000 mcd or more. In other words, among the light-emitting elements included in the light-emitting section 2, the light-emitting element having a peak wavelength in the range of 600 nm or more and 700 nm or less has a luminous intensity of 1000 mcd or more, more preferably 2000 mcd or more, and still more preferably 3000 mcd or more. In this case, the light at the high wavelength side can be reliably received (detected) so that the accuracy of measurement of, in particular, the hemoglobin A1c level is expected to be increased. More preferably, the light-emitting element having a peak wavelength in the range of 630 nm or more and 700 nm or less has a luminous intensity of 1000 mcd or more, more preferably 2000 mcd or more, and still more preferably 3000 mcd or more.

The light-receiving section 3 includes one, two, or more light-receiving elements, and is arranged so that light emitted from the light-emitting section 2 (light-emitting elements) and reflected by the blood-specimen-applying portions 5 of the test pieces 200 can be received. The light-receiving section 3 may either include a single light-receiving element for each light-emitting element or two or three light-receiving elements for each light-emitting element. A suitable number of light-receiving elements may be arranged in accordance with the corresponding light-emitting element. The light-receiving section 3 preferably includes a light-receiving element capable of receiving two or more types of light having different wavelengths (multiple-wavelength light-receiving element) so that the size of the device can be reduced.

In the measuring device 100 illustrated in FIGS. 1 to 3, the light-receiving section 3 includes a light-receiving element 3a illustrated in FIG. 2 that receives light emitted from the light-emitting element 2a and a light-receiving element 3bb′ illustrated in FIG. 3 that receives light emitted from the light-emitting element 2bb′. In this case, the light-receiving element 3bb′, which corresponds to the light-emitting element 2bb′ that is a multiple-wavelength light-emitting element, is a multiple-wavelength light-receiving element. When, for example, light having a wavelength for detecting a color change caused by hemoglobin is emitted from the light-emitting element 2bb′, the light-receiving element 3bb′ receives this light. When light having a wavelength for detecting a color change caused by glycated hemoglobin is emitted from the light-emitting element 2bb′, the light-receiving element 3bb′ receives this light.

The light-receiving section 3 included in the measuring device 100 illustrated in FIGS. 1 to 3 may include light-receiving elements 3b and 3b′ illustrated in FIG. 5 instead of the light-receiving element 3bb′ illustrated in FIG. 3. In the configuration illustrated in FIG. 5, the light-receiving elements 3b and 3b′ are provided for the light-emitting element 2b, which is a multiple-wavelength light-emitting element. The light-receiving elements 3b and 3b′ respectively receive light having a wavelength for detecting a color change caused by hemoglobin and light having a wavelength for detecting a color change caused by glycated hemoglobin.

In the case where the light-emitting section 2 is structured as illustrated in FIG. 4, the light-receiving section 3 includes a light-receiving element 3b that receives light reflected by the front surface of the test piece 200b and a light-receiving element 3b′ that receives light reflected by the back surface of the test piece 200b, as illustrated in FIG. 4.

Alternatively, as illustrated in FIG. 13, the light-receiving section 3 may include a multiple-wavelength light-receiving element 3abb′ that receives light emitted from the three light-emitting elements 2a, 2b, and 2b′.

The light-receiving elements included in the light-receiving section 3 are not limited as long as the light emitted from the corresponding light-emitting elements can be received. The light-receiving elements may be, for example, photodiodes.

In the case where the measuring device includes a single test-piece-mounting section 1, the light-emitting section 2 and the light-receiving section 3 may, for example, be structured as illustrated in FIG. 6. More specifically, a single light-emitting element 2a and a single light-receiving element 3a may be arranged on the front side of the test piece 200 and a single light-emitting element 2bb′, which is a multiple-wavelength light-emitting element, and two light-receiving elements 3b and 3b′ are arranged on the back side of the test piece 200. In this case, when the blood glucose level is to be measured, light having a wavelength for detecting a color change caused by glucose is emitted by the light-emitting element 2a and received by the light-receiving element 3a. When the hemoglobin A1c level is to be measured, light having a wavelength for detecting a color change caused by hemoglobin and light having a wavelength for detecting a color change caused by glycated hemoglobin are emitted by the light-emitting element 2bb′ at different times and received by the light-receiving elements 3b and 3b′, respectively.

Alternatively, two light-emitting elements and three light-receiving elements may be arranged as illustrated in FIG. 6, and the light-emitting element 2a and the light-receiving element 3a may be configured to respectively emit and receive one of light having a wavelength for detecting a color change caused by hemoglobin and light having a wavelength for detecting a color change caused by glycated hemoglobin. In this case, a color change caused by hemoglobin and a color change caused by glycated hemoglobin can be simultaneously detected when the hemoglobin A1c level is to be measured. Therefore, the measurement speed can be increased. In this case, one of the two light-receiving elements 3b and 3b′ illustrated in FIG. 6 receives light having a wavelength for detecting a color change caused by glucose, and the other receives light having a wavelength for detecting a color change caused by hemoglobin or glycated hemoglobin. When the color change cased by glucose is compared with the color change caused by hemoglobin or glycated hemoglobin, the color changed by hemoglobin or glycated hemoglobin has a lower reflectance. Therefore, preferably, the light-receiving element 3b, which is closer to the test piece 200, receives the light having a wavelength for detecting a color change caused by hemoglobin or glycated hemoglobin and the light-receiving element 3b′, which is farther from the test piece 200, receives the light having a wavelength for detecting a color change caused by glucose.

The operating section 4 is electrically connected to the light-receiving section 3 so that electrical signals can be transmitted (circuit for transmitting the electrical signals is shown by bold arrows in the figures). The operating section 4 includes a CPU (storage unit) that calculates the blood glucose level and the hemoglobin A1c level of the blood specimen on the basis of photometric values transmitted from the light-receiving section 3 as electrical signals.

As in the measuring device 100 illustrated in FIG. 1, a measuring device according to the present invention may include a power switch 6 and a monitor 7 that is electrically connected to the operating section 4 and displays the measurement results on the basis of electric signals transmitted from the operating section 4 (circuit for transmitting the electrical signals is shown by bold arrows in the figures). The measuring device according to the present invention may further include a USB connector used to transmit the measurement results to a storage device, such as a PC. Such an USB connector is convenient because the measurement results of the blood glucose level, which is particularly frequently measured, may be recorded and managed by using a PC or the like. The measuring device according to the present invention may additionally have structures and members (for example, a sound generator) of conventionally known POC devices (such as SMBG devices) as appropriate.

In the measuring device 100 illustrated in FIG. 1, it is assumed that the test pieces 200 are mounted into the device after the blood specimen is applied to the test pieces 200. Alternatively, however, a specimen-introducing hole may be formed in an upper section of the device, and the blood specimen may be dropped into the specimen introducing hole and guided to test pieces that are mounted in the device in advance.

The measuring device according to the present invention may be used as a POC device. Therefore, the measuring device 100 has a length of 100 mm or less, a width of 70 mm or less, and a thickness of 30 mm or less, for example, and the weight thereof is 150 g or less, more preferably 100 g or less.

(Test Piece)

The test piece is mounted into the measuring device according to the present invention each time a measurement is performed. The test piece (A), which carries a composition (a) that reacts with glucose and changes color, is mounted when the blood glucose level is to be measured. The test piece (B), which carries a composition (b) that reacts with glycated hemoglobin and changes color, is mounted when the hemoglobin A1c level of the blood specimen is to be measured.

The test piece (each of the test piece (A) and the test piece (B)) includes a base plate that carries a composition (composition (a) or composition (b)) that is configured to react with glucose or hemoglobin A1c contained in the blood specimen and change color and that contains a predetermined enzyme and a redox color reagent. The base plate may be formed of, for example, polyesters, polyamides, polyethersulfones or celluloses. The enzyme is selected from, for example, glucose oxidase (GOD), peroxidase (POD), fructosyl-amino acid oxidase (FAOD), and protease. The redox color reagent includes, for example, 4-aminoantipyrine (4AA) as a coupler and a Trinder reagent, such as N-ethyl-N-(2-hydroxy-3-sulfopropyl)-m-toluidine sodium salt (TOOS; absorption wavelength λmax=555 nm), N-ethyl-N-(2-hydroxy-3-sulfopropyl)-3,5-dianiline (MAOS; absorption wavelength λmax=630 nm), or N-ethyl-N-(2-hydroxy-3-sulfopropyl)-3,5-dimethoxyaniline (DAOS; absorption wavelength λmax=593 nm) as a phenolic hydrogen donor; or leuco dye DA-67 (absorption wavelength λmax=666 nm) or DA-64 (absorption wavelength λmax=727 nm) other than Trinder reagents.

The composition (a) carried by the test piece (A) preferably contains glucose oxidase (GOD), peroxidase (POD), and a redox color reagent. The composition (b) carried by the test piece (B) preferably contains protease, fructosyl-amino acid oxidase (FAOD), peroxidase (POD), and a redox color reagent. When the compositions contain these components, the test pieces reliably and efficiently react with glucose and glycated hemoglobin contained in the blood specimen and change color.

The shapes and sizes of the test pieces 200 (test piece (A) and test piece (B)) are not particularly limited. When, for example, two test-piece-mounting sections are provided as illustrated in FIG. 1 and the test pieces (A) and (B) are mounted into the respective test-piece-mounting sections, the test pieces (A) and (B) are preferably designed to have different shapes or sizes. Thus, in the case where the test-piece-mounting section for measuring the blood glucose level and the test-piece-mounting section for measuring the hemoglobin A1c level are provided, the test pieces to be mounted into the respective test-piece-mounting sections may have different shapes or sizes. In such a case, insertion of the wrong one of the test pieces (A) and (B) can be prevented.

The test pieces 200 may have the shape of, for example, a rectangular, circular, or elliptical thin plate. The test pieces 200 are preferably as small as possible from the viewpoint of reducing the size of the device. For example, when the test pieces 200 have the shape of a rectangular thin plate, the test pieces 200 have a length of 30 mm or less, a width of 20 mm or less, and a thickness of 5 mm or less.

Each of the test pieces 200 (test piece (A) and test piece (B)) may be provided with a bar code or an IC chip that allows the measurement item corresponding to the test piece to be recognized. In particular, in the case where the measuring device includes only one test-piece-mounting section 1, the measurement item can be reliably recognized and light having a wavelength corresponding to the measurement item can be reliably emitted when the test piece mounted into the measuring device has a bar code or an IC chip that allows the measurement item to be recognized.

(Measurement Principle)

The measuring device according to the present invention measures both the blood glucose level and the hemoglobin A1c level by causing a reaction that causes a test piece to change color and detecting the level of the color change by using reflection of light (so-called enzyme colorimetric method). Since the blood glucose level and the hemoglobin A1c level are measured on the basis of the same measurement principle, a reduction in size of the device is achieved. The measurement principle will now be described.

[Measurement of Blood Glucose Level]

To measure the blood glucose level, first, glucose contained in the blood specimen is caused to react with the composition (a) so that the test piece (A) changes color. For example, in the case where the composition (a) contains the above-described preferred components, glucose contained in the blood specimen applied to the test piece reacts with glucose oxidase contained in the composition (a), so that gluconolactone and hydrogen peroxide are generated. The hydrogen peroxide reacts with the redox color reagent and peroxidase, so that the test piece (A) changes color. Subsequently, the portion whose color has changed is irradiated with light having a specific wavelength, and the reflected light is measured to detect the level of the color change. The wavelength of the irradiating light may be determined in accordance with the redox color reagent that is used. The blood glucose level is calculated on the basis of the thus-obtained photometric value. The detailed calculating method may be similar to that of a conventionally known blood glucose level measurement technology using the enzyme colorimetric method (see, for example, Japanese Unexamined Patent Application Publication No. 2009-233253).

In the blood glucose level measurement, the above-described reaction for causing the test piece to change color occurs inside the test piece that carries the composition. Therefore, the reaction immediately occurs when the blood specimen (whole blood) is applied to the test piece, and the test piece normally changes color within several seconds after the application of the blood specimen. Therefore, according to the measuring device of the present invention, the measurement speed can be increased.

An example of a procedure for measuring the blood glucose level will now be described.

i) First, to measure a reference value (blank value), the test piece 200 is irradiated with light λd having a specific absorption wavelength of the dye before the blood specimen is applied to the test piece 200. The light λ1 having the absorption wavelength of the dye is used to detect that the blood specimen has been absorbed by the test piece 200 and a color change has occurred.

ii) After the blood specimen has been absorbed by the test piece and a color change has been detected, the light-emitting section 2 (light-emitting element) emits the light λ1 for a certain time at certain intervals. The light λ1 is reflected by the test piece 200 and received by the light-receiving section 3 (light-receiving element). The intensity (photometric value) of the light λ1 received by the light-receiving section 3 is transmitted to the operating section 4 as an electrical signal and is stored in a storage unit included in the operating section 4.

iii) The operating section 4 is configured to perform a step of calculating a reflectance R (%) on the basis of the intensity (photometric value) of the received light λ1. Accordingly, the reflectance R is calculated.

iv) Subsequently, the operating section 4 converts the calculated reflectance R into a K/S value on the basis of the Kubelka-Munk formula (following Equation (1)).

$$\begin{matrix}[ Equation 1 ] & \\ K / S = \frac{{( 1 - R )}^{2}}{2 \times R} & ( 1 )\end{matrix}$$

(In Equation (1), R represents the reflectance, K represents the absorption coefficient, and S represents the scattering coefficient)

v) The relationship between the blood glucose level and the K/S value (standard curve) is stored in the storage unit of the operating section 4 in advance, and the blood glucose level is calculated on the basis of the standard curve. The calculated blood glucose level is transmitted to the display monitor 7 as an electrical signal and displayed.

In the blood glucose level measurement, the above-described reaction for causing the test piece to change color occurs inside the test piece that carries the composition. Therefore, the reaction immediately occurs when the blood specimen (whole blood) is applied to the test piece, and the test piece normally changes color within several seconds after the application of the blood specimen. Therefore, according to the measuring device of the present invention, the measurement speed can be increased.

[Measurement of Hemoglobin A1c Level]

To measure the hemoglobin A1c level, concentrations of hemoglobin A1c (glycated hemoglobin) and hemoglobin in the blood specimen are determined, and the hemoglobin A1c level is calculated on the basis of the determined concentrations.

To determine the concentration of glycated hemoglobin, first, glycated hemoglobin contained in the blood specimen is caused to react with the composition (b) so that the test piece (B) changes color. For example, in the case where the composition (b) contains the above-described preferred components, glycated dipeptide (fructosyl valyl histidine) at N-end of hemoglobin β chain in the blood specimen is cut off by the action of protease, and the glycated dipeptide reacts with fructosyl peptide oxidase, so that hydrogen peroxide is generated. The hydrogen peroxide reacts with the redox color reagent and peroxidase, so that the test piece (B) changes color. Subsequently, the portion whose color has changed is irradiated with light having a specific wavelength, and the reflected light is measured to detect the level of the color change. The wavelength of the irradiating light may be determined in accordance with the redox color reagent that is used. The concentration of glycated hemoglobin can be determined on the basis of the thus-obtained photometric value.

The concentration of hemoglobin can be determined by measuring the hemoglobin contained in the blood specimen in terms of, for example, the absorbance of light having a wavelength of 475 nm.

The hemoglobin A1c level expressed in terms of molar ratio (mmol/mol), that is, the International Federation of Clinical Chemistry (IFCC) value, can be calculated on the basis of the above-described concentration of glycated hemoglobin (HbA1c concentration) and the above-described concentration of hemoglobin (total Hb concentration) from the following Equation (2).

IFCC value (mmol/mol)=(HbA1c concentration)/(total Hb concentration)×1000 (2)

The hemoglobin A1c level may also be expressed in terms of percentage as the Japan Diabetes Society (JDS) value. The JDS value may be obtained by converting the IFCC value obtained by the above Equation (2) into the JDS value by using the following Equation (3).

JDS value (%)=0.0963×(IFCC value)+1.62 (3)

Here, “(HbA1c concentration)/(total Hb concentration)” in the above Equation (2) is an example of a process of calculating the hemoglobin A1c level, and it is not always necessary to perform an intermediate calculation.

In the hemoglobin A1c level measurement, all of the above-described reactions for causing the test piece to change color occur inside the test piece that carries the composition. Therefore, the reaction immediately occurs when the blood specimen (whole blood) is applied to the test piece, and the test piece normally changes color within several seconds after the application of the blood specimen. Therefore, according to the measuring device of the present invention, the measurement speed can be increased.

An example of a procedure for measuring the hemoglobin A1c level will now be described.

I) First, to measure a reference value (blank value), the test piece 200 is irradiated with light λ2 having a specific absorption wavelength of the dye (specific absorption wavelength of glycated hemoglobin) and light λ3 having a specific absorption wavelength of hemoglobin. The light λ2 having the absorption wavelength of the dye is used to detect that the blood specimen has been absorbed by the test piece 200 and a color change has occurred.

II) After the blood specimen has been absorbed by the test piece and a color change has been detected, the light-emitting section 2 (light-emitting element) emits the light λ2 and light λ3 for a certain time at certain intervals. The light λ2 and light λ3 are reflected by the test piece 200 and received by the light-receiving section 3 (light-receiving element). The intensities (photometric values) of the light λ2 and light λ3 received by the light-receiving section 3 are transmitted to the operating section 4 as electrical signals and are stored in the storage unit included in the operating section 4.

III) The operating section 4 is configured to perform a step of calculating reflectances R (%) on the basis of the intensities (photometric values) of the received light λ2 and light λ3. Accordingly, the reflectance R (R2) of the light λ2 and the reflectance R (R3) of the light λ3 are calculated.

IV) Subsequently, the operating section 4 converts the calculated reflectance R (R2) and the reflectance R (R3) of light λ3 into a K/S value (2) and a K/S value (3), respectively, on the basis of the above-described Kubelka-Munk formula (Equation (1)).

V) Subsequently, the operating section 4 calculates the K/S Ratio from the K/S value (3) corresponding to hemoglobin and the K/S value (2) corresponding to the dye by using the following Equation (4).

K/S Ratio=(K/S value (2))/(K/S value (3)) Eq. (4)

VI) The relationship between the hemoglobin A1c level and the K/S Ratio (standard curve) is stored in the storage unit of the operating section 4 in advance, and the hemoglobin A1c level is calculated on the basis of the standard curve. The calculated hemoglobin A1c level is transmitted to the display monitor 7 as an electrical signal and displayed.

The above-described calculations may be performed by two typical methods for enzyme analysis, that is, an end point assay and a rate assay (initial velocity assay). Each of the measurement of blood glucose level and the measurement of hemoglobin A1c level may be performed by either of these methods. The measurement of blood glucose level and the measurement of hemoglobin A1c level are preferably both performed by the rate assay from the viewpoint of increasing the measurement speed. In the case where the rate assay is used, when, for example, the hemoglobin A1c level is measured, the hemoglobin A1c level may be calculated on the basis of the photometric values at intervals of 10 to 20 seconds for a time period of 20 to 300 seconds from the time of detection of the occurrence of a color change, preferably at intervals of 10 seconds for a time period of 20 to 60 seconds and at intervals of 20 seconds for a time period of 60 to 300 seconds from the time of detection of the occurrence of color change. When the blood glucose level is to be measured, the blood glucose level may be calculated on the basis of the photometric value at, for example, intervals of 10 seconds for a time period of 60 seconds from the time of detection of the occurrence of a color change.

(Measuring Method)

According to a measuring method of the present invention, the blood glucose level and the hemoglobin A1c level of the blood specimen are both measured by using a measuring device including a light-emitting section capable of emitting two types of light having different wavelengths. More specifically, the above-described measuring device according to the present invention is used. The above-described test piece (A) is used as a test piece when the blood glucose level of the blood specimen is to be measured, and the above-described test piece (B) is used as a test piece when the hemoglobin A1c level of the blood specimen is to be measured. Since the predetermined test pieces are selectively mounted in accordance with the measurement item, the blood glucose level and the hemoglobin A1c level can both be measured by a single device. In the case where a measuring device including a single test-piece-mounting section is used, the test piece (A) is mounted into the single test-piece-mounting section when the blood glucose level of the blood specimen is to be measured and the test piece (B) is mounted into the single test-piece-mounting section when the hemoglobin A1c level of the blood specimen is to be measured.

For example, when the measuring device 100 illustrated in FIGS. 1 to 3 is used, a blood specimen is applied to one of the test pieces 200, and the test piece 200 is mounted into the corresponding test-piece-mounting section 1. The light-emitting section 2 emits light toward the mounted test piece 200 (toward the blood-specimen-applying portion 5 to be exact), and the light reflected by the test piece 200 is received by the light-receiving section 3. The operating section 4 calculates the blood glucose level or the hemoglobin A1c level on the basis of the obtained photometric value. In this method, the only processes that are actually performed by an operator include turning on and off the power switch 6, mounting the test piece into the device, and applying the blood specimen to the test piece. Therefore, the operator is not required to perform complex processes such as a front-end process for the specimen, and the measurement is very simple.

According to the present invention, whole blood is used as the blood specimen subjected to the measurement. The amount of blood specimen required for each of the measurement of blood glucose level and the measurement of hemoglobin A1c level is normally 10 μL or less, preferably 5 μL or less, more preferably 3 μL or less, and still more preferably 1 μL or less. According to the device of the present invention, even when the amount of blood specimen is very small as described above, the blood glucose level and the hemoglobin A1c level can be accurately measured. However, if the amount of blood specimen is too small, there is a risk that the accuracy of the measurement values will be reduced. Therefore, the amount of blood specimen is preferably 0.01 μL or more, more preferably 0.05 μL or more, and still more preferably 0.1 μL or more.

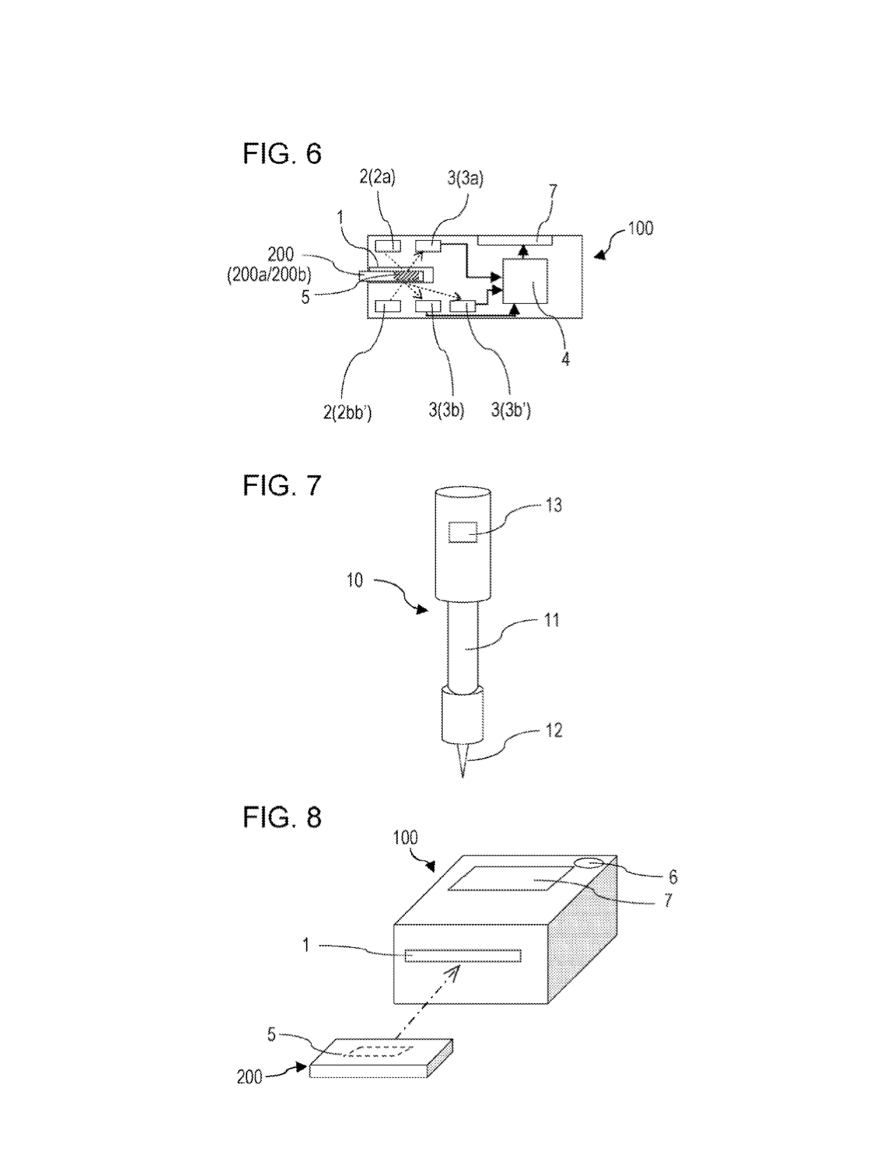

The blood specimen subjected to the measurement according to the present invention may be collected by using, for example, a blood collection needle 10 illustrated in FIG. 7. The blood collection needle 10 includes a main body 11 and a replaceable needle 12 that is detachably attached to the main body 11. The needle 12 projects outward when a button 13 is pressed. When the button 13 is pressed while the needle 12 of the blood collection needle 10 is pointed toward, for example, a finger, the needle 12 projects outward and the finger bleeds. A few drops of blood are obtained in this manner, and the obtained blood is applied to the test piece 200.

### EXAMPLES

### Example 1

A blood glucose level and a hemoglobin A1c level were measured by using the measuring device 100 illustrated in FIGS. 1 to 3.

(Measurement of Blood Glucose Level)

The power switch 6 of the measuring device 100 was turned on in advance so that the light-emitting element 2a and the light-receiving element 3a were operatively associated with each other and light having a wavelength of 630 nm was emitted from the light-emitting element 2a. A test piece carrying a composition (a) containing glucose oxidase (GOD) (produced by Toyobo Co., Ltd.), peroxidase (POD) (produced by Toyobo Co., Ltd.), and 4-aminoantipyrine/N-ethyl-N-(2-hydroxy-3-sulfopropyl)-3,5-dianiline (4AA-MAOS) as a redox color reagent was prepared as the test piece (A), and about 5 μL of blood specimen (whole blood) was applied to the test piece (A). As a result, the color of the test piece (A) was changed from white to blue within several seconds. The test piece (A) whose color had been changed was immediately inserted into the test-piece-receiving hole 1a in the measuring device 100. In the measuring device 100, the light having the wavelength of 630 nm was reflected by the test piece (A) and received by the light-receiving element 3a, and the obtained photometric value was transmitted to the operating section 4. The blood glucose level was calculated by the CPU included in the operating section 4. The photometric value obtained when the test piece (A) that does not have the blood specimen (whole blood) applied thereto is irradiated with similar light was input to the operating section 4 of the measuring device 100 in advance as the blank value. The photometric value was transmitted to the operating section 4 at intervals of 10 seconds for a time period of 60 seconds from the start of the measurement, and the measurement result was calculated by the rate assay. The thus-obtained measurement result was displayed on the display monitor 7. The power switch 6 was turned off after the measurement.

(Measurement of Hemoglobin A1c Level)

The power switch 6 of the measuring device 100 was turned on in advance so that the light-emitting element 2bb′, which was a multiple-wavelength light-emitting element, and the light-receiving element 3bb′, which was a multiple-wavelength light-receiving element, were operatively associated with each other and light having a wavelength of 475 nm was emitted from the light-emitting element 2bb′. A test piece carrying a composition (b) containing protease (produced by Toyobo Co., Ltd.), fructosyl-amino acid oxidase (FAOD) (produced by Toyobo Co., Ltd.), peroxidase (POD) (produced by Toyobo Co., Ltd.), and leuco dye DA-67 as a redox color reagent was prepared as the test piece (B), and about 5 μL of blood specimen (whole blood) was applied to the test piece (B). As a result, the color of the test piece (B) was changed from white to blue within several seconds. The test piece (B) whose color had been changed was immediately inserted into the test-piece-receiving hole 1b in the measuring device 100. In the measuring device 100, first, the light having the wavelength of 475 nm was reflected by the test piece (B) and received by the light-receiving element 3bb′. Subsequently, light having a wavelength of 660 nm was emitted from the light-emitting element 2bb′, reflected by the test piece (B), and received by the light-receiving element 3bb′. The obtained photometric values were transmitted to the operating section 4, and the hemoglobin A1c level was calculated by the CPU included in the operating section 4. The photometric value obtained when the test piece (B) that does not have the blood specimen (whole blood) applied thereto is irradiated with similar light was input to the operating section 4 of the measuring device 100 in advance as the blank value. The photometric values were transmitted to the operating section 4 at intervals of 10 seconds for a time period of 300 seconds from the start of the measurement, and the measurement result was calculated by the rate assay. The thus-obtained measurement result was displayed on the display monitor 7. The power switch 6 was turned off after the measurement.

### Example 2

A blood glucose level and a hemoglobin A1c level were measured by using the measuring device 100 illustrated in FIGS. 1 to 3.

(Measurement of Blood Glucose Level)

The power switch 6 of the measuring device 100 was turned on in advance so that the light-emitting element 2a and the light-receiving element 3a were operatively associated with each other and light having a wavelength of 550 nm was emitted from the light-emitting element 2a. A test piece carrying a composition (a) containing glucose oxidase (GOD) (produced by Toyobo Co., Ltd.), peroxidase (POD) (produced by Toyobo Co., Ltd.), and 4-aminoantipyrine/N-ethyl-N-(2-hydroxy-3-sulfopropyl)-m-toluidine sodium salt (4AA-TOOS) as a redox color reagent was prepared as the test piece (A), and about 5 μL of blood specimen (whole blood) was applied to the test piece (A). As a result, the color of the test piece (A) was changed from white to purple red within several seconds. The test piece (A) whose color had been changed was immediately inserted into the test-piece-receiving hole 1a in the measuring device 100. In the measuring device 100, the light having the wavelength of 550 nm was reflected by the test piece (A) and received by the light-receiving element 3a, and the obtained photometric value was transmitted to the operating section 4. The blood glucose level was calculated by the CPU included in the operating section 4. The photometric value obtained when the test piece (A) that does not have the blood specimen (whole blood) applied thereto is irradiated with similar light was input to the operating section 4 of the measuring device 100 in advance as the blank value. The photometric value was transmitted to the operating section 4 at intervals of 10 seconds for a time period of 60 seconds from the start of the measurement, and the measurement result was calculated by the rate assay. The thus-obtained measurement result was displayed on the display monitor 7. The power switch 6 was turned off after the measurement.

(Measurement of Hemoglobin A1c Level)

The power switch 6 of the measuring device 100 was turned on in advance so that the light-emitting element 2bb′, which was a multiple-wavelength light-emitting element, and the light-receiving element 3bb′, which was a multiple-wavelength light-receiving element, were operatively associated with each other and light having a wavelength of 540 nm was emitted from the light-emitting element 2bb′. A test piece carrying a composition (b) containing protease (produced by Toyobo Co., Ltd.), fructosyl-amino acid oxidase (FAOD) (produced by Toyobo Co., Ltd.), peroxidase (POD) (produced by Toyobo Co., Ltd.), and 4-aminoantipyrine/N-ethyl-N-(2-hydroxy-3-sulfopropyl)-3,5-dianiline (4AA-MAOS) as a redox color reagent was prepared as the test piece (B), and about 5 μL of blood specimen (whole blood) was applied to the test piece (B). As a result, the color of the test piece (B) was changed from white to blue within several seconds. The test piece (B) whose color had been changed was immediately inserted into the test-piece-receiving hole 1b in the measuring device 100. In the measuring device 100, first, the light having the wavelength of 540 nm was reflected by the test piece (B) and received by the light-receiving element 3bb′. Subsequently, light having a wavelength of 630 nm was emitted from the light-emitting element 2bb′, reflected by the test piece (B), and received by the light-receiving element 3bb′. The obtained photometric values were transmitted to the operating section 4, and the hemoglobin A1c level was calculated by the CPU included in the operating section 4. The photometric value obtained when the test piece (B) that does not have the blood specimen (whole blood) applied thereto is irradiated with similar light was input to the operating section 4 of the measuring device 100 in advance as the blank value. The photometric values were transmitted to the operating section 4 at intervals of 10 seconds for a time period of 300 seconds from the start of the measurement, and the measurement result was calculated by the rate assay. The thus-obtained measurement result was displayed on the display monitor 7. The power switch 6 was turned off after the measurement.

The measuring device and the measuring method according to the present invention have been specifically described with reference to the drawings. However, the present invention is not limited to the illustrated examples, and may be implemented with modifications as appropriate within the spirit of the present invention described above and below. Such modifications are also included in the technical scope of the present invention.

### REFERENCE SIGNS LIST

100 measuring device
200 test piece
1 test-piece-mounting section
2 light-emitting section
3 light-receiving section
4 operating section
5 blood-specimen-applying portion
6 power switch
7 display monitor
10 blood collection needle
11 main body of blood collection needle
12 needle
13 button

1. A measuring device for measuring a blood glucose level and a hemoglobin A1c level of a blood specimen, the measuring device comprising:
a light-emitting section that emits illuminating light toward the blood specimen;
a light-receiving section that receives reflected light from the blood specimen; and
an operating section that calculates each of the blood glucose level and the hemoglobin A1c level of the blood specimen on the basis of a photometric value obtained from the light-receiving section,
wherein the light-emitting section is capable of emitting two or more types of light having different wavelengths.

2. The measuring device according to claim 1, wherein the light-emitting section is capable of emitting three types of light having different wavelengths.

3. The measuring device according to claim 2, wherein one of the three types of light having different wavelengths is light having a specific wavelength that is absorbed by a portion whose color has changed in response to glucose contained in the blood specimen and the remaining two of the three types of light having different wavelengths are two types of light having different specific wavelengths that are absorbed by respective portions whose colors have changed in response to hemoglobin and glycated hemoglobin contained in the blood specimen.

4. The measuring device according to claim 1, further comprising a test-piece-mounting section that detachably mounts a test piece to which the blood specimen is applied.

5. A measuring device for measuring a blood glucose level and a hemoglobin A1c level of a blood specimen, the measuring device comprising:
a test-piece-mounting section that detachably mounts a test piece to which the blood specimen is applied;
a light-emitting section that emits illuminating light toward the test piece;
a light-receiving section that receives reflected light from the test piece; and
an operating section that calculates each of the blood glucose level and the hemoglobin A1c level of the blood specimen on the basis of a photometric value obtained from the light-receiving section,
wherein a test piece (A) that carries a composition (a) that reacts with glucose and changes color is mounted as the test piece to measure the blood glucose level of the blood specimen, and a test piece (B) that carries a composition (b) that reacts with glycated hemoglobin and changes color is mounted as the test piece to measure the hemoglobin A1c level of the blood specimen.

6. The measuring device according to claim 5, wherein the light-emitting section is capable of emitting three types of light having different wavelengths.

7. The measuring device according to claim 1, wherein the light-emitting section includes at least one light-emitting element capable of emitting two or more types of light having different wavelengths.

8. The measuring device according to claim 7, wherein the light-emitting section includes a light-emitting element capable of emitting three types of light having different wavelengths.

9. The measuring device according to claim 5, wherein the light-emitting section includes three light-emitting elements, one of which emits light toward one side of the test piece and the remaining two of which emit light toward the other side of the test piece.

10. The measuring device according to claim 5, wherein the light-emitting section includes a light-emitting element having a peak wavelength of 600 nm or more and a luminous intensity of 1000 mcd or more.

11. The measuring device according to claim 5, wherein two of the test-piece-mounting sections are provided, and the test piece mounted by one of the two test-piece-mounting sections and the test piece mounted by the other of the two test-piece-mounting sections have different shapes or sizes.

12. The measuring device according to claim 5, wherein the test-piece-mounting section has a test-piece-receiving hole, and the test-piece-receiving hole has an edge portion that guides the test piece (A) and an edge portion that guides the test piece (B), which has a shape different from a shape of the test piece (A).

13. A measuring method comprising measuring both a blood glucose level and a hemoglobin A1c level of a blood specimen by using a measuring device including a light-emitting section capable of emitting two or more types of light having different wavelengths.

14. A measuring method using a measuring device including
a test-piece-mounting section that detachably mounts a test piece to which a blood specimen is applied,
a light-emitting section that emits illuminating light toward the test piece,
a light-receiving section that receives reflected light from the test piece, and
an operating section that calculates each of a blood glucose level and a hemoglobin A1c level of the blood specimen on the basis of a photometric value obtained from the light-receiving section,
wherein a test piece (A) that carries a composition (a) that reacts with glucose and changes color is used as the test piece when the blood glucose level of the blood specimen is to be measured, and a test piece (B) that carries a composition (b) that reacts with glycated hemoglobin and changes color is used as the test piece when the hemoglobin A1c level of the blood specimen is to be measured, and
wherein the measuring method comprises applying the blood specimen to the test piece, emitting the illuminating light toward the test piece with the light-emitting section, receiving the reflected light from the test piece with the light-receiving section, and calculating the blood glucose level or the hemoglobin A1c level with the operating section on the basis of the obtained photometric value.

15. The measuring method according to claim 14, wherein the measuring device includes one of the test-piece-mounting section, and wherein the test piece (A) is mounted by the one test-piece-mounting section when the blood glucose level of the blood specimen is to be measured and the test piece (B) is mounted by the one test-piece-mounting section when the hemoglobin A1c level of the blood specimen is to be measured.

16. The measuring method according to claim 14, wherein the composition (a) contains glucose oxidase, peroxidase, and a redox color reagent, and the composition (b) contains protease, fructosyl-amino acid oxidase, peroxidase, and a redox color reagent.
